(19) United States
(12) Patent Application Publication
(10) Pub. No.: US 2007/0170270 A1
(43) Pub. Date: Jul. 26, 2007

(54) Waste water heat recovery system and method

(75) Inventors: Jeff Jelinek, Hammond, IN (US); Ryan Hardesty, Chesterton, IN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/337,516

(22) Filed: Jan. 24, 2006

(51) Int. Cl. G05D 23/185

(52) U.S. Cl. 236/12.11

(57) ABSTRACT

A controller for a waste water heat recovery system includes a processor configured to process data received from sensors. The controller receives data from a cold water sensor, a second receiver for receiving data from a hot water sensor and a third receiver for data from a waste water sensor. Further, the controller transmits a controller to a water flow director. Other embodiments of the invention may include a method controlling recovery of waste water heat, including detecting a water temperature of various locations and hot water supply and dispensing system flowing dispensed hot water through a heat exchanger to heat water flowing into a hot water supply and controlling a water director that can selectively supply water to the heat exchanger and the disposal system based on the detected water temperatures.

### FIELD OF THE INVENTION

The present invention relates generally to a control system for a waste water heat recovery system. More particularly, the present invention relates to harvesting heat from discarded waste water, and using the harvested heat to preheat water coming from a water source to a hot water generator such as a boiler or hot water heater or other device designed and configured to generate hot water.

### BACKGROUND OF THE INVENTION

Both commercial and domestic hot water systems consume a lot of energy heating water. This is due in part to the high heat capacity of water and the amount of energy required to change the temperature of water. In domestic settings, most hot water systems use a hot water heater that may be electric or gas powered to heat water from a water source such as a municipal water system or well water. Other systems may use boilers.

Commercial hot water systems may also use boilers or hot water heaters. The hot water is used to provide hot water for showers tubs, sinks, dishwashers, laundry or any other use for hot water. Many uses for hot water are high consumption uses. As a result, a large amount of the water, while still hot, goes down the drain. One classical example of this is a shower. After the water from a shower goes down the drain, often it will still contain a large amount of heat, which is wasted as the waste water goes through a water disposal system such as a septic system or municipal sewer. Because many hot water systems are wasteful and inefficient in that water is sent to disposal systems while containing large amounts of heat, a system will be desirable that could harvest heat from waste water and, thus, improve the overall efficiency of a hot water system.

Because of the large heat capacity of water, it is, in some instances, an efficient way to carry heat from one place to another. Examples of using water for heat include hot water heating systems where hot water is circulated in a radiator in various rooms or areas in the radiator to facilitate the removal of heat from the hot water into the air and into the room. Another example of using hot water for heat is a hydronic system. In some hydronic systems, hot water may pass through a serpentine tubing contained within flooring or any other area where the heat is desired and as the hot water passes through the serpentine tubing system, heat is transferred from the water into the surrounding material. This type of system is often embedded in a floor, and permits the floor to be heated. Accordingly, it is desirable for a hot water system whether it be a hydronic system, a heating system, or a domestic hot water generating system to be more efficient in order to reduce the amount of energy required to provide hot water at a desired temperature.

### SUMMARY OF THE INVENTION

The foregoing needs are met, to a great extent, by the present invention, wherein in one aspect an apparatus is provided that in some embodiments a controller for a waste water heat recovery system is provided. The controller includes a processor configured to process data received from sensors, the processor configured to receive data from a cold water sensor, the processor configured to receive data from a hot water sensor, the processor configured to receive data from a waste water sensor and the processor is configured to transmit a signal to a water flow director.

In accordance with another embodiment of the present invention, a controller for a waste water heat recovery system is provided. The controller includes a processor configured to process data received from sensors, means for inputting cold water data into the processor, means for inputting hot water data into the processor, means for inputting dispensed hot water data into the processor, means for directing the flow for dispensed hot water to at least two pathways and means for controlling the means for directing flow, the means for controlling including the processor.

In accordance with yet another embodiment of the present invention, a method for controlling recovery of waste water heat is provided. The method includes detecting water temperature at various locations at a hot water supply dispensing and disposal system, flowing dispensed hot water through a heat exchanger to heat water flowing into a hot water supply, and controlling a water director that selectively supplies water to the heat exchanger and the disposal system based on the detected water temperatures.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic drawing of a hot water supply and dispensing system according to an embodiment of the invention.

FIG. 2 is a schematic diagram of a hot water supply and dispensing system according to a second embodiment of the invention.

FIG. 3 is a flow chart illustrating a sequence of steps accomplished according to an embodiment of the invention.

### DETAILED DESCRIPTION

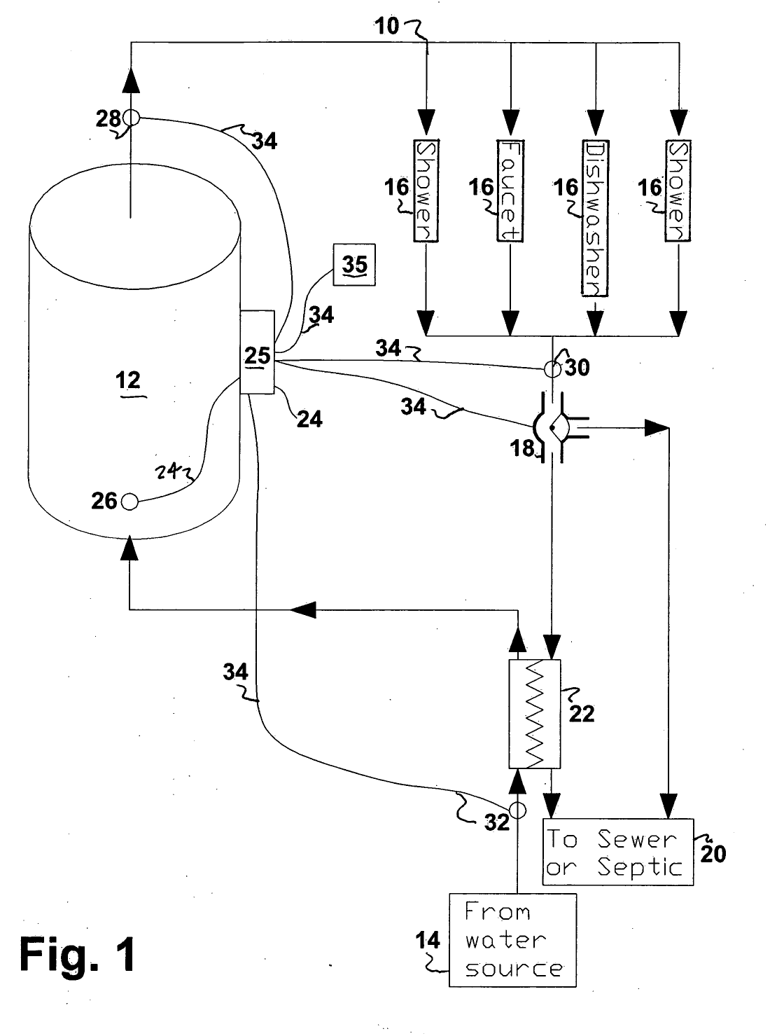

The invention will now be described with reference to the drawing figures in which like referenced numerals refer to like parts throughout. An embodiment in accordance with the present invention is illustrated in FIG. 1. A domestic hot water (DHW) system 10 is illustrated in FIG. 1. The DHW system includes a DHW source 12, which can be a hot water heater, a boiler, a storage tank or any other device for generating and storing hot water. The DHW source 12 is supplied water from a water source 14. The water source 14 can be a municipal water supply, a well, or any other suitable source of water for heating in the DHW source 12.

The DHW source 12 supplies water to a variety of hot water dispensers 16. Hot water dispensers can be a shower or tub, a faucet, dishwasher, a washing machine or any other appliance or dispenser of hot water in a typical hot water supply and dispensing system.

Once the hot water has been dispensed by a hot water dispenser 16, it typically flows down a drain but still retains a significant amount of heat. This heat can be harvested for a variety of things including heating fresh water that will be used and supplied to the domestic hot water source.

According to some embodiments of the invention (and as shown in FIG. 1) after the hot water is dispensed from the hot water dispenser 16, it flows to a hot water flow controller 18. The hot water flow controller may be a three-way

valve as illustrated in FIG. 1. The hot water flow controller 18 can selectively allow the hot water to flow to a water disposal system 20 such as a septic system or to a municipal sewer system or any other system for disposing of waste water.

Alternatively, the water flow controller 18 can selectively allow the dispensed hot water to flow to a heat exchanger 22 where the heat exchanger permits the dispensed hot water to exchange heat with cold water coming from a water source 14 on its way to the domestic hot water source 12. Thus, the cold water from the water source 14 can be preheated in the heat exchanger 22, where heat is harvested from the waste hot water and put into the water flowing into the domestic hot water source. The preheating of the cold water on its way to the domestic hot water source can reduce the amount of energy required to heat the water in the domestic hot water source 12 to a desired temperature, thus increasing the overall efficiency of the system 10. Once the dispensed hot water has passed through the heat exchanger 22, it then is sent to a water disposal system 20 such as a septic system or a municipal sewer system or any other appropriate water disposal system.

As illustrated in FIG. 1, the domestic hot water system 10 is controlled by a controller 24. The controller 24 includes a processor 25, which processes data received from several inputs and has an output of a control signal to the water flow controller 18. In some embodiments of the invention, the controller 24 can also control the operation of the domestic hot water source 12. Control functions that may be controlled by the controller 24 can include, but are not limited to, turning on the domestic hot water source 12 to generate hot water, heating water to a selected temperature range or to turn off the heating system if the hot water in the domestic hot water 12 has reached an inappropriate temperature.

Inputs to the controller 24 include sensors 26, 28, 30, 32. In some embodiments of the invention, a sensor 26 is located to detect the temperature of water being input to the DHW source 12. A second sensor 28 is placed to detect the temperature of the water in the domestic hot water source. Alternatively, it can be placed to detect a temperature of the hot water flowing out of the DHW source 12, which is usually at or very close to the temperature of the hot water within the DHW source. A third sensor 30 may be used to detect a temperature of the dispensed hot water after it has been dispensed from the hot water dispenser 16. The sensor may be located in a drain to detect the temperature of the dispensed hot water (a/k/a waste water). Other embodiments of the invention may also include a fourth sensor 32 configured to detect a temperature of water coming from a water source 14.

As illustrated in FIG. 1, the sensor 32 may be placed in the system 10 before the water flows through a heat exchanger 22. The sensors 26, 28, 30, 32 are operatively connected to the controller 24. They may be connected by wire, cable connections 34, as illustrated in FIG. 1 or in wireless connections or any other suitable type of connection. Similarly, the water flow controller 18 is operatively connected to the controller 18 and may be connected by a cable or wire type of connection 34, as shown in FIG. 1 or it may be a wireless connection or any other suitable type of connection.

The controller 24 sends control signals to the water flow controller 18 to selectively allow the water flow controller 18 to allow the dispensed hot water (a/k/a waste water) to the heat exchanger 22 or it may direct the waste water to the water disposal system 20. The controller receives the inputs from the sensors 26, 28, 30, 32 and processes these inputs to generate a control signal for the water flow controller 18. The controller may select what type of control signals are given to the water flow controller 18 based on an algorithm that may be preprogrammed into the controller 24 or selected by an operator of the controller 24. For example, the algorithm may seek to optimize different variables based on the selected algorithm. For example, the algorithm programmed into the controller 24 may optimize fuel efficiency thus making controlling decisions based on generating hot water of a predetermined temperature requiring the least amount of energy. Alternatively, the algorithm can optimize time, in other words, making the most amount of hot water in the least amount of time. One skilled in the art will recognize other types of variables or factors that may optimized and programmed into the controller 24.

In some embodiments of the invention, the controller 24 may be integrated with the control system for the domestic hot water source 24 and the use of embodiments. The controller 24 will also be input with signals obtained from a thermostat 35. By using a thermostat 35, a user of the system 10 can specify a specific temperature or range of temperatures in which the domestic hot water source 12 outputs hot water. For example, many domestic hot water sources 12, such as water heaters, will permit an acceptable range of temperatures for the hot water to be outputted from the domestic hot water source 12. In some cases this range may be about 10 degrees. Thus, the domestic hot water source 12 can heat water 10 degrees higher than some minimum temperatures then the heating elements will be turned off and the domestic hot water source 12 will essentially be a storage unit. Once the heating elements are turned off, the water within the domestic hot water source 12 will cool off about 10 degrees due to heat being lost to the environment or from hot water being drawn from the domestic hot water source 12 and cold water being input from the water source 12 into the domestic hot water source 12 before the hot water heater will turn back on the heating elements.

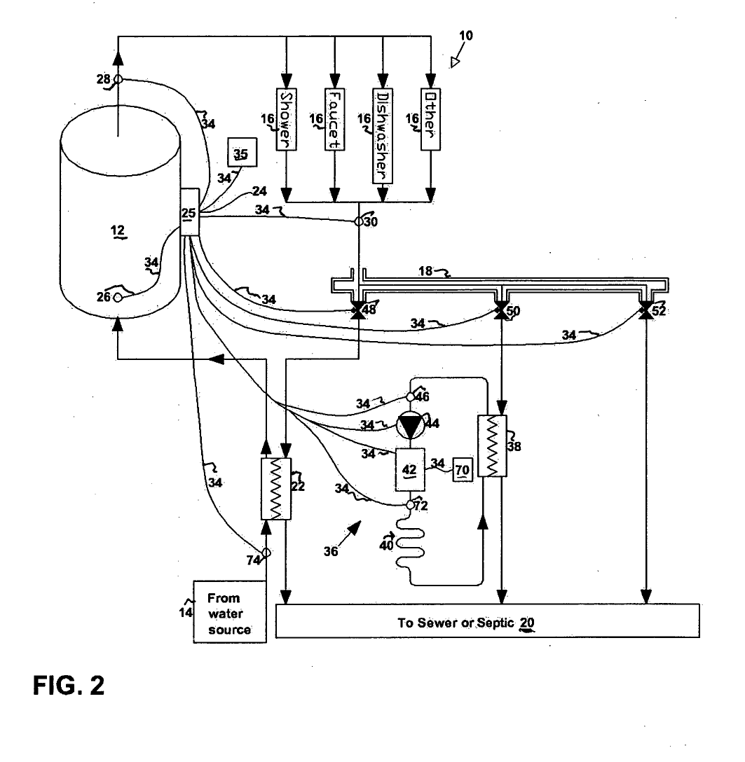

FIG. 2 is an illustration of a domestic hot water system 10, which includes a hydronic system 36. The hydronic system 36 is used to provide hot water for heating for certain parts of a building or home. For example, a restroom or bathroom in a home may be heated hydronically. For example, a bathroom floor may have a serpentine system of pipes 40 embedded in it. Hot or warm water flows through those pipes 40. Heat escapes from the hot water flowing through the pipes into the surrounding floor material thus heating the floor.

Waste water heat may be used in a hydronic system 36 in various ways. For example, in one way, the waste water is simply diverted to flow through the serpentine tubing before flowing to a water disposal system 20.

In other instances, as shown in FIG. 2, heat from waste water flows through a heat exchanger 38 before it is sent to a water disposal system 20. In the heat exchanger 38, heat from the dispensed hot water or waste water is transferred to water contained in the closed hydronic circuit. The water in the closed hydronic circuit flows through the heat exchanger 38 and then to a pump 44 which provides the pressure for flowing the water through the hydronic circuit 36. Water is given additional heating with a water heater 42 which may be an electric or gas hot water heater or any other device suitable for heating hot water. The water flows through the warming coils 40 which are often in a serpentine type of arrangement embedded in a floor, walls, or any other desired structure to be heated. After the water has flowed through the warming coils 40, a substantial amount of the heat will have transferred from the water to the structure surrounding the coils. The water is then flowed through the heat exchanger 38 where it can then be reheated by waste water prior to achieving its full desired temperature which it achieves in the water heater 42.

In some embodiments of the invention, the hydronic system 36 is in communication with the controller 24. For example, as shown in FIG. 2, the water heater 42 and the pump 44 are connected to the controller 24 via connections 34. In some embodiments of the invention, these connections may be wire or cable connections. Alternatively, they may can also be wireless connections or any other connections suitable for transmitting signals between the water heater 42, the pump 44 and the controller 24.

The controller 24 can send control signals to both the hot water heater 42 and the pump 34. In some embodiments of the invention, the hydronic system 34 may have a thermostat 70 to provide a desired amount of heat by the user of the hydronic system. The thermostat 70 may be associated with the water heater 42 and information given to the water heater 42 from the thermostat 70 may also be communicated to the controller 24 and used in the algorithm processed by the processor in the controller 24 for sending control signals to the hot water heater 12, the water flow controller 18, the pump 44 and the hot water heater 42.

FIG. 2 illustrates a DHW system 10 similar to the DHW system 10 shown in FIG. 1 with the addition of a hydronic system 36 and a modified water flow controller 18. Similar to that illustrated in FIG. 1, water flows from a water source 14, such as a well or municipal water system to a heat exchanger 22 before the water enters the hot water source 12, which may be a boiler or hot water heater or any other suitable device for providing hot water. Water is heated within the hot water source 12 and exits as illustrated to a variety of hot water dispensers 16, which may be a shower, faucet, dishwasher, laundry facilities or any other hot water dispensing device. The hot water dispensing device 16 generates waste water which often contains a significant amount of heat which then goes down the drain. The waste water going down the drain flows into a water flow controller 18. The water flow controller 18, as shown in FIG. 2, contains multiple pathways and valves 48, 50 and 52. The valves 48, 50 and 52 are operatively connected to a controller 24.

The controller 24 can open and shut the valves 48, 50 and 52. If the controller 24 sends control signals to valves 48, 50 and 52 so that valve 48 is open and valves 50 and 52 are shut then the waste water flows through the heat exchanger 22 thus preheating water arriving from the water source 14 to the domestic hot water source 12. After flowing through the heat exchanger 22, the waste water then flows to a water disposal system such as a sewer septic system 20 as previously described. If the controller 24 sends control signals to valves 48,50 and 52, such that valves 48 and 50 are closed and valve 52 is open, then the waste water flows directly from the water flow controller 18 to a water disposal system 20. If the controller 24 controls the valves 48, 50 and 52 such that valves 48 and 52 are shut, and valve 50 is open, then the waste water from the hot water dispenser 16 flows through the water flow controller 18 to the heat exchanger 38. The waste water then exchanges heat from the waste water into the water contained in the hydronic system 36 thus preheating the water and the hydronic system 36 before it enters the water heater 42.

The more the water in the hydronic zone 36 can be preheated in the heat exchanger 38, than the less energy will be required to heat the water in the hydronic zone 36 to the desired temperature in the water heater 42. In the embodiment shown in FIG. 2, an additional sensor 46 has been added with a connection 34 to the controller 24. The sensor 46 senses the water temperature of the water before it enters the water heater 42. Information given to the controller 24 about the water temperature before it enters the water heater 42 and the hydronic zone 36 is used in the algorithm used by the controller 24 to provide control signals to the pump 44 and the water heater 42.

In some embodiments of the invention, the water heater 42 is fitted with a thermostat control 70, which connects to the water heater 42 and ultimately to the controller 24 via connections 34. The controller 24 will also use the data input to the thermostat 70 to use in its algorithm for controlling the water heater. In some embodiments of the invention will include a second water temperature sensor 72 to determine the temperature of the water be outputted by the water heater 42. The sensor 72 is connected to a controller 24 via connection 34, as illustrated in FIG. 2. The connection may be cable, wireless or any suitable type of connection.

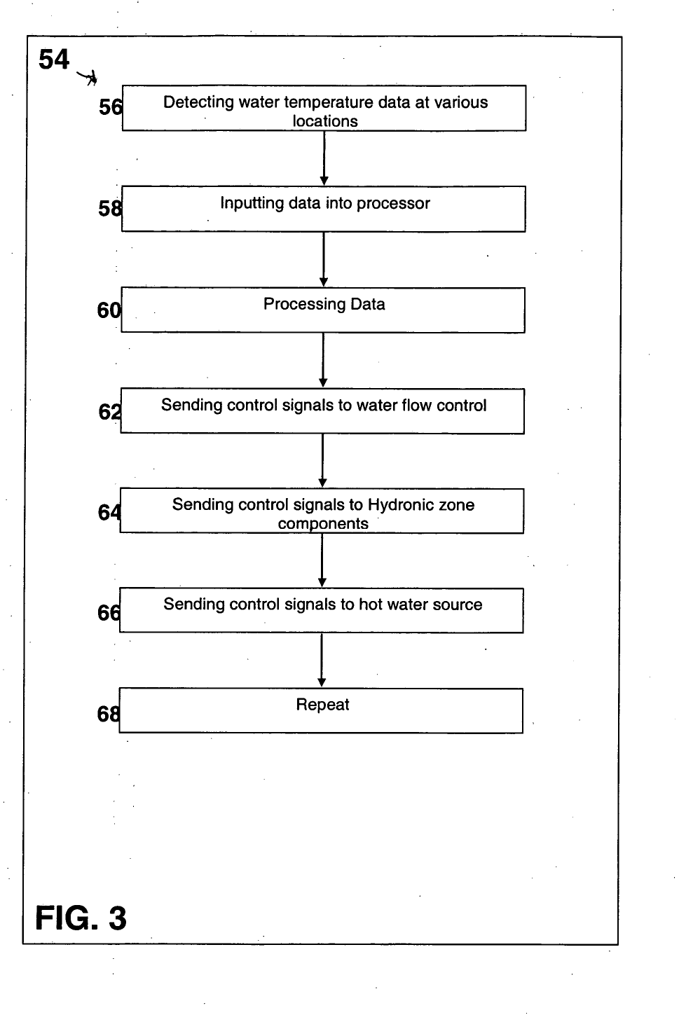

FIG. 3 is a flowchart illustrating steps for controlling a domestic hot water system 10 according to one embodiment of the invention. The system 54 includes a first step 56 of detecting water temperature data at various locations. Some of the locations may optionally include water being inputted into the domestic hot water source, water in the domestic hot water source, water being outputted from the domestic hot water source, and temperature of waste water being outputted into the water flow controller 18. Other embodiments of the invention may include detecting water temperature of water entering a hot water heater and a hydronic zone and the water in the hot water heater or exiting hot water heater.

The next step 58 includes inputting data from the sensors into the processor. The next step 60 is processing the data according to a predetermined algorithm to generate control signals.

The next step 62 is to send control signals to a water flow control which may include a variety of valves. The next step 64 in the method 54 is an optional step and includes sending control signals to hydronic zone components. The hydronic zone components may include a pump and a hot water heater.

Another optional step 66 in the method 54 is to send control signals to a hot water source, such as a hot water heater or boiler. Another optional step 68 is to repeat the previously-described steps of the method 54 as required.

It is anticipated that embodiments of the invention will include a controller with sensors and connections to controlling an existing domestic hot water system. Other embodiments of the invention will include components of a domestic hot water system, especially the hot water source, hydronic system and components that will come with the control system and sensing system already integrated into the components. While the system has been described primarily with respect to a home or domestic hot water system, the invention can also be applied, in some embodiments, to commercial operations such as hotels, businesses and any other system where hot water is generated and used.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be.resorted to, falling within the scope of the invention.

What is claimed is:

1. A controller for a wastewater heat recovery system comprising:
a processor configured to process data received from sensors;
the processor configured to receive data from a cold water sensor;
the processor configured to receive data from a hot water sensor;
the processor configured to receive data from a waste water sensor; and
the processor configured to transmit a signal to a water flow director.

2. The controller of claim 1, further comprising at least one of: a first sensor operatively connected to the processor, a second sensor operatively connected to the processor, and a third sensor operatively connected to the processor.

3. The controller of claim 1, further comprising a water flow director configured to be operatively connected to the processor to receive and respond to the signal.

4. The controller of claim 3, wherein the water flow director includes a three-way valve.

5. The controller of claim 1, wherein the controller is operatively connected to a water heating device.

6. The controller of claim 5, wherein the controller is operatively connected to means for flowing water through a hydronic zone.

7. The controller of claim 1, further comprising;
a hot water source;
a hot water dispenser configured to receive hot water from the hot water source, and provide hot water to the water flow director, wherein the water flow director is configured to selectively direct the hot water to at least one of at least two conduits dependant upon the signal received from the controller; and
a heat exchanger configured to exchange heat between hot water from the water director and water entering the hot water source.

8. The controller of claim 1, further comprising a hydronic zone wherein the hydronic zone is controlled at least in part, by the controller.

9. The controller of claim 8, wherein the hydronic zone comprises a second heat exchanger configured to exchange heat from hot water provided to the second heat exchanger from the water flow director and water to be circulated in the hydronic zone.

10. The controller of claim 9, further comprising a sensor operatively connected to the controller to provide data to the controller regarding water temperature in the hydronic zone.

11. The controller of claim 10, wherein the hydronic zone further comprises at least one of a pump and a hot water heater operatively connected to the controller and controlled at least in part by the controller.

12. The controller of claim 8, wherein the water flow director is configured to selectively direct water received from the hot water dispenser to: a heat exchanger configured to exchange heat with water to flow into a hot water source; a heat exchanger associated with a hydronic zone; and a waste water disposal system.

13. The controller of claim 12, wherein the water flow director comprises three valves:
a valve to selectively permit water to flow to the heat exchanger configured to exchange heat with the water to flow into the hot water source;
a valve to selectively permit water to flow into the hydronic zone; and a valve configured to selectively permit water to flow to the waste water disposal system, and
wherein the three valves are operatively connected to the controller and are controlled by the controller.

14. The controller of claim 1, wherein the water flow director comprises multiple valves and the valves are operatively connected to the controller and are controlled by the controller.

15. The controller of claim 1, wherein the controller is configured to send control signals to a hot water source.

16. A controller for a wastewater heat recovery system comprising:
a processor configured to process data received from sensors;
means for inputting cold water data into the processor;
means for inputting hot water data into the processor;
means for inputting dispensed hot water data in to the processor;
means for directing flow of dispensed hot water to at least two pathways and means for controlling the means for directing flow, the means for controlling including the processor.

17. The controller of claim 16, wherein the means for direction flow is configured to supply water to means for exchanging heat.

18. The controller of claim 16, wherein the means for direction flow is configured to supply water to a means for exchanging heat with a hydronic zone.

19. The controller of claim 16, wherein the controller is configured to control a hot water source.

20. A method controlling recovery of waste water heat comprising:
detecting water temperature a various locations in a hot water supply dispensing and disposal system;
flowing dispensed hot water through a heat exchanger to heat water flowing into a hot water supply; and
controlling a water director that can selectively supply water to the heat exchanger and the disposal system based on the detected water temperatures.

21. The method of claim 20, further comprising selectively flowing dispensed hot water through the water director to a heat exchanger associated with a hydronic zone.

22. The method of claim 20, further comprising dispensing hot water with a domestic hot water dispenser.

23. The method of claim 20, further comprising controlling sending control signals to a hot water source.
